(19) United States
(12) Patent Application Publication
(10) Pub. No.: US 2020/0180170 A1
(43) Pub. Date: Jun. 11, 2020

(54) CONVERTIBLE UTILITY KNIFE

(71) Applicant: TECHTRONIC CORDLESS GP, Anderson, SC (US)

(72) Inventors: Jacob F. Creasman, Anderson, SC (US); Clinton C. Thackery, Clemson, SC (US); Richard M. Davidian, Pickens, SC (US); John D. Schaalje, Williamston, SC (US)

(21) Appl. No.: 16/704,159

(22) Filed: Dec. 5, 2019

Related U.S. Application Data
(60) Provisional application No. 62/775,478, filed on Dec. 5, 2018.

(51) Int. Cl. B26B 1/06; B26B 5/00

(52) U.S. Cl. CPC B26B 1/06; B26B 1/10; B26B 5/003

(57) ABSTRACT

A utility knife is provided for supporting a blade in use, the blade defining a cutting edge, the utility knife including a handle portion, a blade holder positioned proximate the handle and defining a longitudinal axis, the blade holder configured for retaining a blade, and a fastener for selectively retaining the blade within the blade holder in a plurality of orientations. In a first orientation the cutting edge extends substantially parallel to the longitudinal axis of the blade holder, and in a second orientation the cutting edge of the blade extends transverse to the longitudinal axis of the blade holder.

### CROSS-REFERENCE TO RELATED APPLICATIONS

This application claims priority to co-pending U.S. Provisional Patent Application No. 62/775,478 filed on Dec. 5, 2018, the entire content of which is incorporated herein by reference.

### FIELD

The present invention relates to utility knives, and more particularly, to a utility knife capable of being converted between a cutting orientation and a scraping orientation.

### BACKGROUND

Utility knives generally include a blade, a handle, and a blade holder engaging both the blade and the handle. Blade holder portions of traditional utility knives are slidably attached to the handle to house the blade within the handle when not in use.

### SUMMARY

The present subject matter provides, in one aspect, a utility knife for supporting a blade in use, the blade defining a cutting edge. The utility knife includes a handle portion, a blade holder positioned proximate the handle and defining a longitudinal axis, the blade holder configured for retaining a blade, and a fastener for selectively retaining the blade within the blade holder in a plurality of orientations. When in a first orientation, the cutting edge extends substantially parallel to the longitudinal axis of the blade holder. When in a second orientation, the cutting edge of the blade extends transverse to the longitudinal axis of the blade holder.

The present subject matter provides, in another independent aspect, a utility knife for supporting a blade in use, the blade defining a cutting edge. The utility knife includes a housing having a first end and a second end, the housing defining a handle portion at the first end, a blade holder positioned at the second end of the housing and configured for retaining the blade, the blade holder defining a longitudinal axis, and a fastener for selectively coupling the blade to the blade holder in a plurality of orientations. When the blade is in a first orientation, the cutting edge extends substantially parallel to the longitudinal axis of the blade holder. When the blade is in a second orientation, the cutting edge of the blade extends transverse to the longitudinal axis of the blade holder.

Other features and aspects of the present subject matter will become apparent by consideration of the following detailed description and accompanying drawings.

### BRIEF DESCRIPTION OF THE DRAWINGS

FIG. 1 is a side view of a utility knife according to one embodiment.

FIG. 2 is a perspective view of the utility knife of FIG. 1 with a portion of a handle removed.

FIG. 3 is an enlarged view of a portion of the utility knife of FIG. 2.

FIG. 4 is a partially exploded view of the utility knife of FIG. 2 with a blade in a first position.

FIG. 5 is a partially exploded view of the utility knife of FIG. 2 with the blade in a second position.

FIG. 6 is a perspective view of a utility knife according to another embodiment.

FIG. 7 is a perspective view of a utility knife according to another embodiment with a blade and a blade carrier in an extended position.

FIG. 8 is a perspective view of the utility knife of FIG. 7 with the blade and the blade carrier in a folded position.

FIG. 9 is a partially exploded enlarged view of a portion of the utility knife of FIG. 7 with the blade in a first position.

FIG. 10 is an enlarged view of a portion of the utility knife of FIG. 7 with the blade in a second position.

FIG. 11 is a cross-sectional view of the utility knife of FIG. 10.

Before any embodiments of the present subject matter are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways. Also, it is to be understood that the phraseology and terminology used herein is for the purpose of description and should not be regarded as limiting.

### DETAILED DESCRIPTION

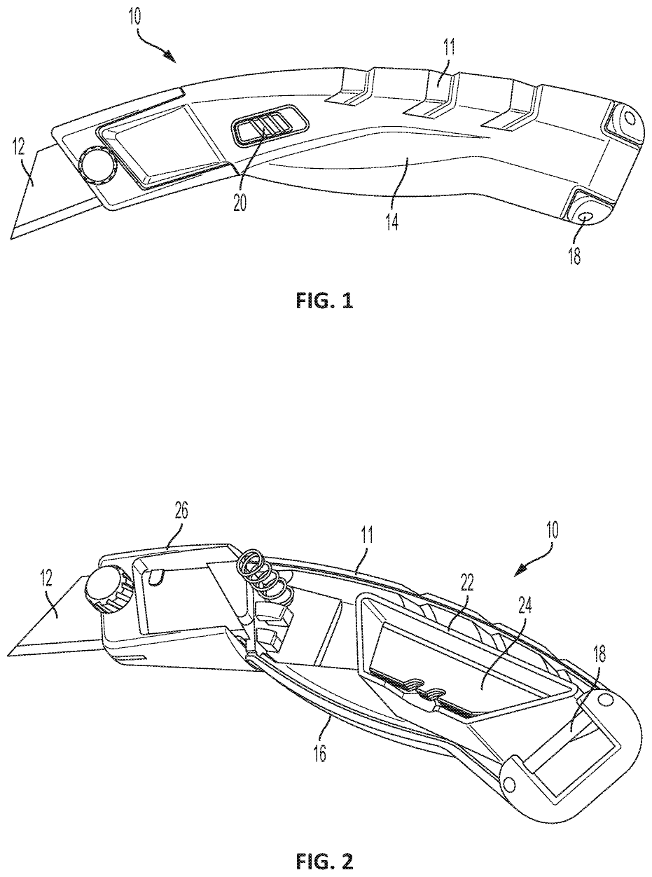

FIGS. 1-5 illustrate a utility knife 10 including a utility knife blade 12. As discussed in more detail below, the utility knife 10 may be used with the blade 12 in a first orientation (see, e.g., FIG. 1) configured for cutting a surface and a second orientation (see e.g., FIG. 5) configured for scraping a surface. The utility knife 10 may be used to cut and/or scrape any suitable surface and/or material including, for example, drywall, cardboard, wire, rope, plastic, glass, and/or the like.

Referring to FIGS. 1 and 2, the knife 10 may include a handle 11 having a first handle portion 14 and a second handle portion 16. In the illustrated embodiment, the first handle portion 14 may be pivotally coupled to the second handle portion 16 via a pivot shaft 18. The knife 10 may include a latch 20 that allows the user to pivot the handle portions 14, 16 for opening and closing the knife 10. In the illustrated embodiment, an internal blade holder 22 may be located inside the handle portions 14, 16 and the handle portions 14, 16 may be opened to access the blade holder 22. The blade holder 22 may include a magnet for holding spare blades 24 inside the holder 22. In other embodiments, the handle portions 14, 16 may be connected in other configurations that may or may not allow the handle portions to separate or open.

Referring to FIG. 2, the knife 10 further includes a primary blade holder 26. The blade holder 26 may fixedly retain and/or couple the blade 12 to the handle 11 so that the blade 12 may be used to cut and/or scrape a surface (e.g., a surface of a workpiece). In the illustrated embodiment, the blade holder 26 may be fixed from movement relative to the handle 11. In other embodiments, as discussed below, the blade holder may be pivotally coupled to the handle. In yet other embodiment, the blade holder may slide into and out of the handle to move the blade 12 into and out of the handle.

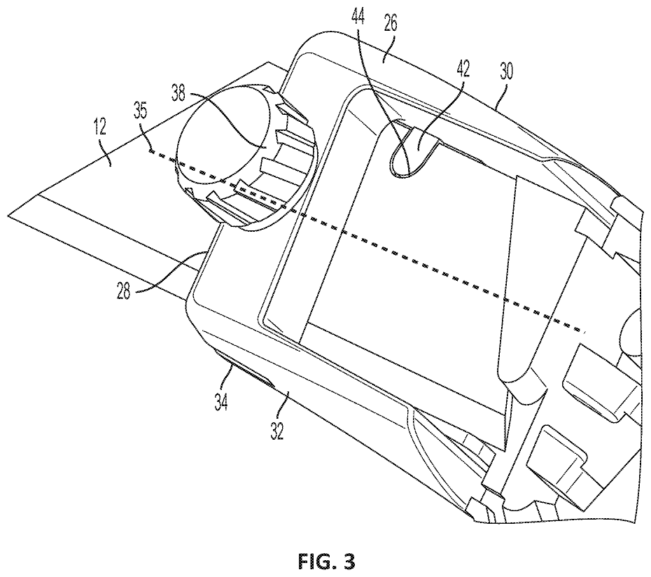

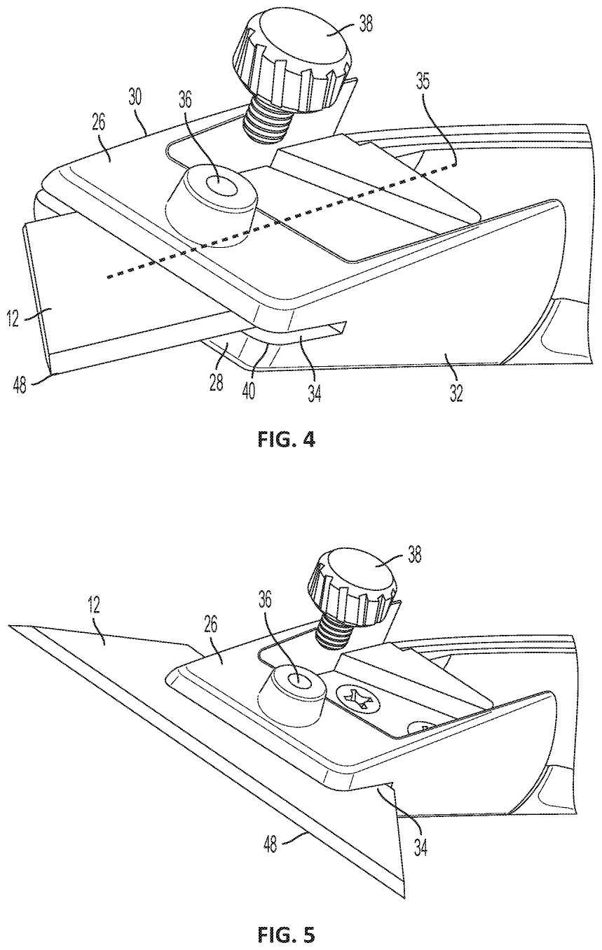

Referring to FIGS. 3 and 4, the blade holder 26 may include a front side 28, a top side 30 adjacent the front side 28, and a bottom side 32 adjacent the front side 28 and opposite the top side 30. The blade holder 26 may further include a blade slot 34 that extends along the front side 28 and at least partially along the top side 30 and to the bottom side 32 as shown in FIGS. 3 and 4. The configuration of the blade slot 34 allows the blade 12 to be coupled to the blade holder 26 in different orientations as described in more detail below. The blade holder 26 defines a blade holder longitudinal axis 35 extending through the blade slot 34 in the front side 28 of the blade holder 26, along the length and centered between both the top side 30 and the bottom side 32 of the blade holder.

With continued reference to FIGS. 3 and 4, the blade holder 26 may additionally include an aperture 36 and a fastener 38 configured for receipt in the aperture 36. In the illustrated embodiment, the aperture 36 may be threaded and the fastener 38 may include a thumbscrew. The fastener 38 may be inserted into the aperture 36 and tightened to press the blade 12 against a sidewall 40 (see, e.g., FIG. 4) of the blade slot 34 for securing the blade 12 to the blade holder 26. In some implementations, the fastener 38 may secure the blade 12 to the blade holder 26 so that the blade 12 is non-retractable relative to the blade holder 26. In this way, the blade 12 may be more firmly and/or securely retained relative to the blade holder 26. In this way, handling and/or use of the blade 12 may be improved. As best seen in FIG. 3, a retention mechanism 42 may be located inside the blade slot 34. In the illustrated embodiment, the retention mechanism 42 is a lobe 42 which may be disposed in a recess 44 of the blade holder 26. The retention mechanism 42 provides additional stability of the blade 12 within the blade holder 26 and the blade slot 34. At a minimum, the retention mechanism 42 engages the blade 12 to prevent motion of the blade 12 in a direction along the longitudinal axis 35 of the blade holder 26. When the blade 12 is provided in the position shown in FIG. 4, the blade 12 may be particularly suited for a cutting operation.

Referring to FIG. 5, the user may couple the blade 12 to the blade holder 26 in a second orientation where the entire blade 12 (e.g., an entire cutting edge 48 of the blade 12) may be exposed and/or extend from the knife 10 for use during a scraping operation. In the exemplary cutting orientation of FIG. 4, a portion of the cutting edge 48 of the blade 12 may remain within the blade holder 26 whereas in the exemplary scraping orientation of FIG. 5, the entire cutting edge 48 of the blade 12 may be exposed and/or disposed outside of the blade holder 26. The blade 12 may be repositioned by way of removing the fastener 38 from the aperture 36. This allows the blade 12 to be slidably moved (e.g., via pulling) out of the slot 34 and rotated. The blade 12 may then be reinserted into the slot 34 and the fastener 38 inserted into the aperture 36 to secure the blade 12 to the blade holder 26. In this configuration, the blade 12 may be particularly suited for a scraping operation (e.g., scraping paint from a surface).

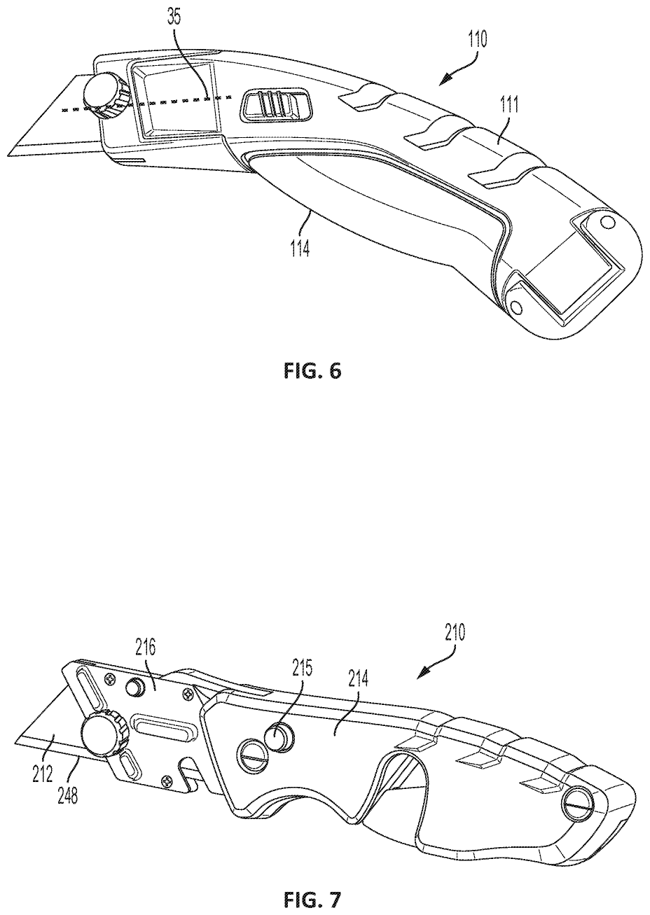

FIG. 6 illustrates a utility knife 110 according to another embodiment. The knife 110 may include features similar to the knife 10 discussed above. In addition, a handle 111 of the knife 110 may include a rubber grip portion 114. In this way, use and/or handling of the knife 110 may be improved by way of the improved grip portion 114.

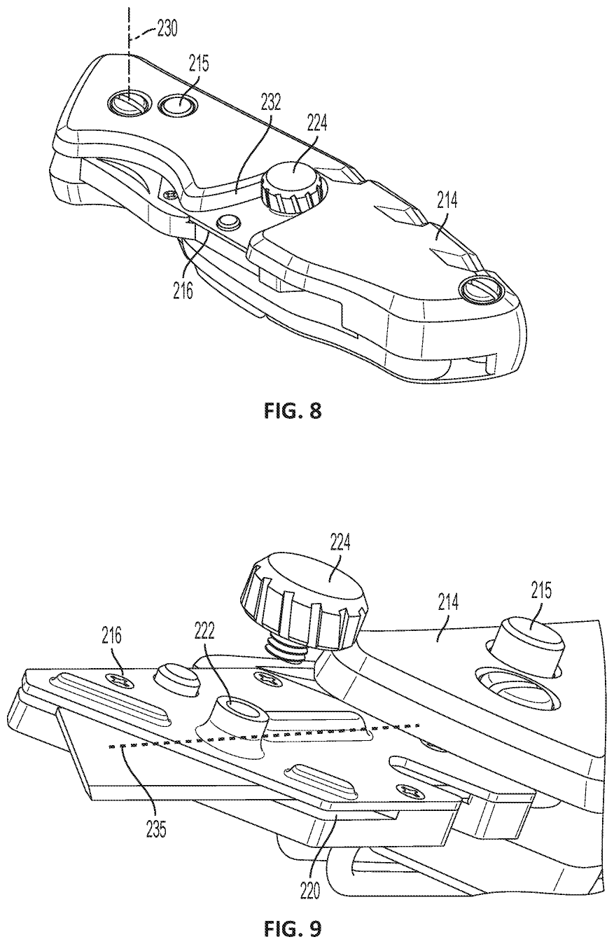

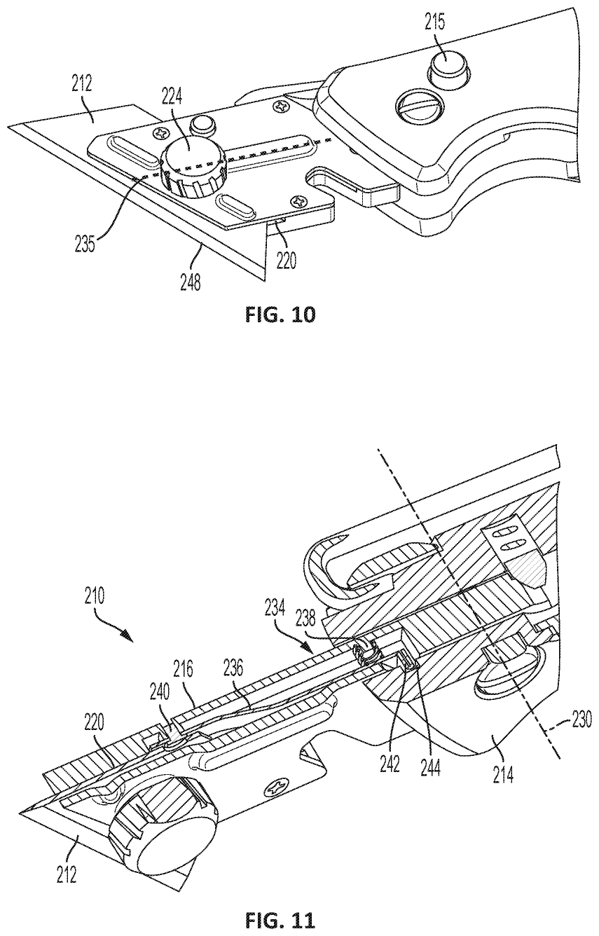

FIGS. 7-11 illustrate a utility knife 210 according to another embodiment. The utility knife 210 may include a blade 212 and a handle 214. The blade 212 may, in some implementations, be arranged in a first orientation relative to the handle 214 for performing a cutting operation (FIGS. 7 and 9) and a second orientation relative to the handle 214 for performing a scraping operation (FIG. 10). The knife 210 may include a primary blade holder 216 that is pivotally coupled to the handle 214 so that the blade 212 may be received within the handle 214 for storage when not in use (FIG. 8). As discussed below, in the illustrated embodiment, the blade 212 and blade holder 216 may be inhibited from pivoting into the handle 214 when the blade 212 is in the second or scraping orientation (FIG. 10). In some implementations, the blade holder 216 may move relative to the handle 214 upon actuating (e.g., depressing, sliding, engaging, pulling, releasing, moving, etc.) a release member 215. In some implementations, the release member 215 may include a knob, a button, a biasing member, a trigger, and/or the like, by which the blade holder 216 may be loosened and/or released relative to the handle 214 for pivoting relative to the handle 214. In a storage position of the blade holder 216, the blade holder 216 is housed substantially within the handle 214 as shown in FIG. 8. In this position, the blade is enclosed by the handle 214, and is not exposed to the surroundings. In a use position or extended position of the blade holder 216, the blade holder 216 projects from the handle 214 as shown in FIGS. 9 and 10. In this position, at least a portion of the blade 212 is exposed to the surroundings. The release member 215 permits the movement of the blade holder 216 relative to the handle 214.

Referring to FIG. 9, the blade holder 216 may include a blade slot 220 having a similar configuration as the blade slot 34 of the knife 10 described above. That is, the blade slot 220 may include a configuration that allows the blade 212 to be coupled to the blade holder 216 in the at least two orientations discussed above (see, e.g., FIGS. 9 and 10). Additionally, the blade holder 216 may include an aperture 222 and a fastener 224 similar to the knife 10 discussed above that removably couples the blade 212 to the blade holder 216 in the different orientations.

Referring to FIGS. 7 and 8, the blade holder 216, and thus the blade 212, may be pivotally coupled to the handle 214 so that the blade holder 216 may pivot relative to the handle 214 about a pivot axis 230. In the folded position (see, e.g., FIG. 8) the blade 212 may be received within a portion of the handle 214. The fastener 224 may be positioned in a recess 232 of the handle 214 in the folded position. In some implementations, the release member 215 may be conveniently accessed by the user (e.g., by way of the user's thumb or finger) to pivot the blade holder 216 about the axis 230 to the open or extended position of FIG. 7. In the open or extended position, the blade 212 may be moved between the different orientations (FIGS. 9 and 10) as described above with regard to the knife 10. The blade holder 216 defines a blade holder longitudinal axis 235 extending through the blade slot 220, along the length and centered within the blade holder 216.

Referring to FIG. 11, the knife 210 may include a retainer 234 configured to maintain the blade holder 216 in the extended position when the blade 212 is in the scraping orientation (see, e.g., FIG. 10). The example retainer 234 depicted in FIG. 22 may include a leaf spring 236, a coil spring 238 at a first end of the leaf spring 236, and a magnet 240 at a second end of the leaf spring 236 opposite the first end. The magnet 240 may be attracted to the blade 212 to facilitate holding the blade 212 within the blade slot 220 in either orientation. When the blade 212 is in the scraping orientation (see e.g., FIG. 11), the coil spring 238 may depress or push a tab 242 of the leaf spring 236 into a recess 244 of the handle 214. With the tab 242 is received in the recesses 244, the handle 214 and the blade holder 216 may be interconnected such that the blade holder 216 is prevented from pivoting about the axis 230 to the folded position of FIG. 19. In this way, the knife 210 may employ a built-in safety mechanism (e.g., including the leaf spring 236 and/or recess 244) to prevent the blade 212 from being folded and/or pivoted relative to the handle 214 when the blade 212 is in the scraping orientation. When the blade 212 is inserted into the blade holder 216 in the cutting orientation (FIG. 9), the blade 212 may press against the leaf spring 236 to remove the tab 242 from the recess 244. With the tab 242 removed from the recess 244, the blade holder 216 may pivot about the axis 230 to the folded or closed position of FIG. 8. Referring to FIGS. 7 and 10, the blade 212 has a cutting edge 248 which may be exposed and/or extend from the knife 210 for use during a scraping orientation. In the exemplary cutting operation of FIG. 7, a portion of the cutting edge 248 of the blade 212 may remain within the blade holder 216 whereas in the exemplary scraping orientation of FIG. 10, the entire cutting edge 248 of the blade may be exposed and disposed outside of the blade holder 216.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the scope of one or more independent aspects as described.

Various features of the present subject matter are set forth in the following claims.

What is claimed is:

1. A utility knife comprising:
a handle portion;
a blade holder positioned proximate the handle and defining a longitudinal axis, the blade holder configured for retaining a blade; and
a fastener for selectively retaining the blade within the blade holder in a plurality of orientations,
wherein, in a first orientation, a cutting edge of the blade extends substantially parallel to the longitudinal axis of the blade holder, and
wherein, in a second orientation, the cutting edge of the blade extends transverse to the longitudinal axis of the blade holder.

2. The utility knife of claim 1, further comprising a retention mechanism within the blade holder for providing additional stability to the blade when the blade is retained in the first orientation.

3. The utility knife of claim 1, wherein the fastener extends through an aperture of the blade holder to selectively engage the blade.

4. The utility knife of claim 1, wherein the handle portion includes a first handle portion and a second handle portion where the first handle portion is pivotally coupled to the second handle portion via a pivot shaft.

5. The utility knife of claim 4, wherein the pivot shaft is located at an end of the knife opposite the blade holder.

6. The utility knife of claim 4, wherein an interior chamber is defined between the first handle portion and the second handle portion, the interior chamber configured for holding additional blades.

7. The utility knife of claim 6, wherein a magnet is located in the interior chamber for holding the additional blades therein.

8. The utility knife of claim 1, wherein the handle includes a rubber grip portion.

9. The utility knife of claim 1, wherein in the first orientation, a portion of the cutting edge is positioned within the blade holder, and in the second orientation, the cutting edge of the blade is positioned outside the blade holder.

10. A utility knife comprising:
a housing having a first end and second end, the housing defining a handle portion at the first end;
a blade holder positioned at the second end of the housing and configured for retaining a blade, the blade holder defining a longitudinal axis; and
a fastener for selectively coupling the blade to the blade holder in a plurality of orientations,
wherein, when the blade is in a first orientation, a cutting edge of the blade extends substantially parallel to the longitudinal axis of the blade holder, and
wherein, when the blade is in a second orientation, the cutting edge of the blade extends transverse to the longitudinal axis of the blade holder.

11. The utility knife of claim 10, wherein the blade holder pivots relative to the handle portion between a use position, in which at least a portion of the blade is exposed, and a storage position, in which the blade is enclosed by the handle portion.

12. The utility knife of claim 10, further comprising a safety mechanism preventing the blade holder from being pivoted relative to the handle portion when the blade is in the second orientation.

13. The utility knife of claim 12, wherein the safety mechanism includes a leaf spring including a tab, a coil spring, and a recess within the handle, wherein when the blade is in the second orientation, the coil spring pushes the tab of the leaf spring within the recess of the handle.

14. The utility knife of claim 13, wherein when the blade is in the first orientation, the blade presses against the leaf spring such that the tab is removed from the recess and the blade holder is permitted to pivot relative to the handle portion.

15. The utility knife of claim 10, further comprising a release member for optionally engaging the blade holder for permitting pivoting motion of the blade holder relative to the handle about a blade holder pivot axis.

16. The utility knife of claim 15, wherein operation of the release member permits movement of the blade holder between the use position and the storage position.

17. The utility knife of claim 10, wherein the blade holder includes a blade slot for allowing the blade to be coupled to the blade holder one of the plurality of orientations.

18. The utility knife of claim 10, wherein the blade holder includes an aperture through which the fastener extends to secure the blade to the blade holder.

19. The utility knife of claim 10, wherein the handle portion includes a first handle portion and a second handle portion, the first handle portion pivotally coupled to the second handle portion.

20. The utility knife of claim 19, wherein an interior chamber is defined between the first handle portion and the second handle portion, the interior chamber configured for holding additional blades.
